(19) United States
(12) Patent Application Publication
(10) Pub. No.: US 2017/0324931 A1
(43) Pub. Date: Nov. 9, 2017

(54) Adjusting Spatial Congruency in a Video Conferencing System

(71) Applicant: Dolby Laboratories Licensing Corporation, San Francisco, CA (US)

(72) Inventors: Xuejing SUN, Beijing (CN); Dong SHI, Shanghai (CN); Shen HUANG, Beijing (CN); Kai LI, Beijing (CN); Hannes MUESCH, Oakland, CA (US); Glenn N. DICKINS, Sydney (AU); Gary SPITTLE, Hillsborough, CA (US)

(73) Assignee: Dolby Laboratories Licensing Corporation, San Francisco, CA (US)

(21) Appl. No.: 15/527,181

(22) PCT Filed: Nov. 17, 2015
(86) PCT No.: PCT/US2015/060994

§ 371 Date: May 16, 2017

Related U.S. Application Data
(60) Provisional application No. 62/086,379, filed on Dec. 2, 2014.

(30) Foreign Application Priority Data
Nov. 19, 2014 (EP) 201410670335.4

(51) Int. Cl. H04N 7/14; H04L 12/18; H04N 7/15

(52) U.S. Cl. CPC H04N 7/147; H04N 7/15; H04L 12/1827; H04S 2400/15

(57) ABSTRACT

Example embodiments disclosed herein relate to spatial congruency adjustment. A method for adjusting spatial congruency in a video conference is disclosed. The method includes detecting spatial congruency between a visual scene captured by a video endpoint device and an auditory scene captured by an audio endpoint device that is positioned in relation to the video endpoint device, the spatial congruency being a degree of alignment between the auditory scene and the visual scene, comparing the detected spatial congruency with a predefined threshold and in response to the detected spatial congruency being below the threshold, adjusting the spatial congruency. Corresponding system and computer program products are also disclosed.

### CROSS-REFERENCE TO RELATED APPLICATIONS

This application claims priority from Chinese Priority Patent Application No. 201410670335.4 filed 19 Nov. 2014 and U.S. Provisional Patent Application No. 62/086,379 filed 2 Dec. 2014, which are hereby incorporated by reference in their entirety.

### TECHNOLOGY

Example embodiments disclosed herein generally relate to audio content processing and more specifically, to a method and system for adjusting spatial congruency, especially in a video conferencing system.

### BACKGROUND

When conducting a video conference, visual signals are generated and transmitted from one side to other side(s) along with auditory signals, so that when one or more conference participants are speaking, the sound produced on the other side(s) should be synchronized and played simultaneously. There mainly exist two kinds of discrepancies between audio and video: discrepancies in time and spatial congruency. Discrepancies in time between audio and video streams can lead to synchronization problems, such as voices from the speaking participants not being synchronized with their mouths. Spatial congruency is a term for describing how much the sound field being played matches the visual scene being displayed. Spatial congruency can also define a degree of alignment between an auditory scene and a visual scene. The example embodiments disclosed herein aims for adjusting spatial congruency in a video conferencing system, so that the auditory scene and the visual scene are matched with each other, presenting an immersive video conferencing experience for the participants on multiple sides.

The users do not need to be concerned about the spatial congruency problem if the audio signal is in mono format which is commonly adopted in many existing video conferencing systems. Spatial congruency happens only when the audio signal is presented in at least two channels, (e.g., stereo). Nowadays, sound can be captured by more than two microphones, which would be transmitted in a multi-channel format, such as 5.1 or 7.1 surround formats, and rendered and played by multiple transducers at the end user. In a typical conference environment, there are several participants surrounding a device for capturing their voices and each of the participants can be seen as a single audio object which generates a series of audio signals upon speaking.

As used herein, the term “audio object” refers to an individual audio element that exists for a defined duration in time in the sound field. An audio object may be dynamic or static. For example, a participant may walk around the audio capture device and the position of the corresponding audio object varies accordingly.

For video conferences and various other applications involving spatial congruency issue, incongruent auditory-visual rendition leads to an unnatural percept which would cause a degraded conferencing experience. In general, a discrepancy less than 5° can be seen as acceptable because such a difference in angle is not significantly noticeable to most people. If the discrepancy in angle is more than 20°, most people find it to be noticeably unpleasant.

In view of the foregoing, there is a need in the art for a solution for adjusting the auditory scene to be aligned with the visual scene or adjusting the visual scene to be aligned with the auditory scene.

### SUMMARY

In order to address the foregoing and other potential problems, the example embodiments disclosed herein proposes a method and a system for adjusting spatial congruency in a video conferencing system.

In one aspect, example embodiments disclosed herein provide a method for adjusting spatial congruency in a video conference. The method include detecting spatial congruency between a visual scene captured by a video endpoint device and an auditory scene captured by an audio endpoint device that is positioned in relation to the video endpoint device, the spatial congruency being a degree of alignment between the auditory scene and the visual scene, comparing the detected spatial congruency with a predefined threshold; and in response to the detected spatial congruency being below the threshold, adjusting the spatial congruency. Embodiments in this regard further include a corresponding computer program product.

In another aspect, example embodiments disclosed herein provide a system for adjusting spatial congruency in a video conference. The system includes a video endpoint device configured to capture a visual scene, an audio endpoint device configured to capture an auditory scene that is positioned in relation to the video endpoint device; a spatial congruency detecting unit configured to detect the spatial congruency between the captured auditory scene and the captured visual scene, the spatial congruency being a degree of alignment between the auditory scene and the visual scene, a spatial congruency comparing unit configured to compare the detected spatial congruency with a predefined threshold and a spatial congruency adjusting unit configured to adjust the spatial congruency in response to the detected spatial congruency being below the threshold.

Through the following description, it would be appreciated that in accordance with the example embodiments, the spatial congruency can be adjusted in response to any discrepancy between the auditory scene and the visual scene. The adjusted auditory scene relative to the visual scene or the adjusted visual scene relative to the auditory scene is naturally presented by multiple transducers (e.g., speakers, headphones and the like) and at least one display. The example embodiments disclosed herein realizes a video conference with a representation of audio in 3D. Other advantages achieved by the example embodiments will become apparent through the following descriptions.

### DESCRIPTION OF DRAWINGS

Through the following detailed descriptions with reference to the accompanying drawings, the above and other objectives, features and advantages of the example embodiments will become more comprehensible. In the drawings, several embodiments will be illustrated in examples and in a non-limiting manner, wherein:

FIG. 1 illustrates a schematic diagram of an audio endpoint device in accordance with an example embodiment;

FIG. 2 illustrates an example coordinate system used for the audio endpoint device as shown in FIG. 1;

FIG. 3 illustrates a flowchart of a method for adjusting spatial congruency in a video conference in accordance with example embodiments;

FIG. 4 illustrates a schematic view captured by a video endpoint device at one side in a video conference in accordance with an example embodiment;

FIG. 5 illustrates a flowchart of a method for detecting the spatial congruency in accordance with example embodiments;

FIG. 6 illustrates an example scenario of a video conference at one side in accordance with an example embodiment;

FIG. 7 illustrates a flowchart of a method for detecting the spatial congruency in accordance with example embodiments;

FIG. 8 illustrates an example scenario of a video conference at one side to be scaled in accordance with an example embodiment;

FIG. 9 illustrates a block diagram of a system for adjusting spatial congruency in a video conference in accordance with an example embodiment; and

FIG. 10 illustrates a block diagram of an example computer system suitable for the implementing embodiments.

Throughout the drawings, the same or corresponding reference symbols refer to the same or corresponding parts.

### DESCRIPTION OF EXAMPLE EMBODIMENTS

Principles of the example embodiments will now be described with reference to various example embodiments illustrated in the drawings. It should be appreciated that the depiction of these example embodiments are only to enable those skilled in the art to better understand and further implement the example embodiments, and is not intended for limiting the scope in any manner.

The example embodiments disclosed herein refers to the technologies involved in a video conferencing system. To conduct a video conference with the audio signal represented in 3D, there must be at least two sides joining the conference, establishing a valid conversation. The two sides can be named as a caller side and a callee side. In one embodiment, the caller side includes at least one audio endpoint device and one video endpoint device. The audio endpoint device is adapted to capture an auditory scene, while the video endpoint device is adapted to capture a visual scene. The captured auditory scene and captured visual scene can be transmitted to the callee side, with the captured auditory scene being played by a plurality of transducers and the captured auditory scene being displayed by at least one screen at the callee side. Such transducers can have many forms. For example, they can be constructed as a sound bar placed beneath a major screen, a multi-channel speaker system with many speakers distributed in the callee's room, stereo speakers on the corresponding personal computers such as laptops of the participants at the callee side, or headphones or headsets worn by the participants. The display screen can be a large display hung on the wall or a plurality of smaller displays on the personal devices.

At the callee side, there can be also included an audio endpoint device for capturing the auditory scene and a video endpoint device for capturing the visual scene to be respectively played and viewed at the caller side. However, in this particular embodiment, it is to be noted that an endpoint device at the callee side is optional, and a video conference or conversation can be established once at least one audio endpoint device is provided with at least one video endpoint device at the caller side. In other embodiments, for example, there is not provided any of the endpoint devices at the caller side, but at least one audio endpoint device is provided with at least one video endpoint device at the callee side. Furthermore, the caller side and the callee side can be swapped, depending on who initiates the video conference.

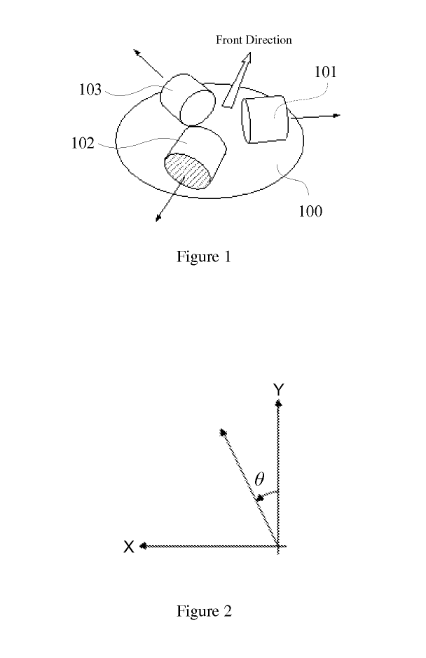

FIG. 1 illustrates a schematic diagram of an audio endpoint device 100 in accordance with an example embodiment. In general, the audio endpoint device 100 contains at least two microphones each for capturing or collecting sound pressure toward it. In one embodiment, as shown in FIG. 1, three cardioid microphones 101, 102 and 103 facing in three different directions are provided in a single audio endpoint device 100. Each of the audio endpoint devices 100 according to this particular embodiment has a front direction which is used for facilitating the conversion of the captured audio data. In this particular embodiment as shown in FIG. 1, the front direction shown by an arrow is fixed relative to the three microphones. There can be provided a right microphone 101 pointing to a first direction, a rear microphone 102 pointing to a second direction, and a left microphone 103 pointing to a third direction. In this particular example embodiment, the first direction is angled clockwise by approximately 60 degrees with respect to the front direction, the second direction is angled clockwise by approximately 180 degrees with respect to the front direction, and the third direction is angled counterclockwise by approximately 60 degrees with respect to the front direction.

It is to be noted that although there can be more than three microphones in one audio endpoint device, three microphones in most cases, can already be used to capture an immersive auditory scene in a space. In a configuration of microphones as illustrated in FIG. 1, the front direction is preset and fixed relative to the microphones for ease of transforming the captured audio signals from the three microphones into “WXY” B-format. For the example using three microphones 101, 102 and 103 in the audio endpoint device 100 as illustrated by FIG. 1, the audio endpoint device 100 can generate LRS signals by the left microphone 103, the right microphone 101, and the rear microphone 102, where L represents the audio signal captured and generated by the left microphone 103, R represents the audio signal captured and generated by the right microphone 101, and S represents the audio signal captured and generated by the rear microphone 102. In one embodiment, the LRS signals can be transformed to the WXY signals by the following equation:

$$[ \begin{matrix}W \\ X \\ Y\end{matrix} ] = [ \begin{matrix}\frac{2}{3} & \frac{2}{3} & \frac{2}{3} \\ \frac{2}{3} & \frac{2}{3} & - \frac{4}{3} \\ \frac{2}{\sqrt{3}} & - \frac{2}{\sqrt{3}} & 0\end{matrix} ] [ \begin{matrix}L \\ R \\ S\end{matrix} ] \qquad ( 1 )$$

In Equation (1), W represents a total signal weighed equally from all of the three microphones 101, 102 and 103, meaning it can be used as a mono output including no position or direction information within the audio signal, while X and Y represent a position of the audio object along X axis and Y axis respectively in an X-Y coordinate system as shown in FIG. 2. In the example shown in FIG. 2, the X axis is defined by the front direction of the audio endpoint device 100, and the Y axis is angled counterclockwise by 90 degrees with respect to the X axis.

Such a coordinate system can be rotated counterclockwise from the X axis by any angle θ and a new WXY sound field can be obtained by the following equation (2):

$$[ \begin{matrix}{W}^{′} \\ {X}^{′} \\ {Y}^{′}\end{matrix} ] = [ \begin{matrix}1 & 0 & 0 \\ 0 & cos ( θ ) & - sin ( θ ) \\ 0 & sin ( θ ) & cos ( θ )\end{matrix} ] [ \begin{matrix}W \\ X \\ Y\end{matrix} ] \qquad ( 2 )$$

By using equation (2), the rotation of the audio endpoint device 100 can be compensated.

Continuing to consider the examples where the surround sound field is generated as B-format signals. It would be readily appreciated that once a B-format signal is generated, W, X and Y channels may be converted to various formats suitable for spatial rendering. The decoding and reproduction of Ambisonics are dependent on the loudspeaker system used for spatial rendering. In general, the decoding from an Ambisonics signal to a set of loudspeaker signals is based on the assumption that, if the decoded loudspeaker signals are played back, a “virtual” Ambisonics signal recorded at the geometric center of the loudspeaker array should be identical to the Ambisonics signal used for decoding. This can be expressed as:

C·L=B (3)

where L={L₁, L₂, . . . , Lₙ}^{T} represents the set of loudspeaker signals, B={W, X, Y, Z}^{T} represents the “virtual” Ambisonics signal assumed to be identical to the input Ambisonics signal for decoding, and C is known as a “re-encoding” matrix defined by the geometrical definition of the loudspeaker array, (e.g., azimuth, elevation of each loudspeaker). For example, given a square loudspeaker array, where loudspeakers are placed horizontally at the azimuth of {45°, −45°, 135°, −135° } and elevation {0°, 0°, 0°, 0° }, this defines C as:

$$C = [ \begin{matrix}1 & 1 & 1 & 1 \\ cos ( 45 ° ) & cos ( - 45 ° ) & cos ( 135 ° ) & cos ( - 135 ° ) \\ sin ( 45 ° ) & sin ( - 45 ° ) & sin ( 135 ° ) & sin ( - 135 ° ) \\ 0 & 0 & 0 & 0\end{matrix} ] \qquad ( 4 )$$

Based on this, the loudspeaker signals can be derived as:

L=D·B (5)

where D represents the decoding matrix typically defined as the pseudo-inverse matrix of C.

In accordance with some embodiments, in binaural rendering, audio is played back through a pair of earphones or headphones. B-format to binaural conversion can be achieved approximately by summing “virtual” loudspeaker array feeds that are each filtered by a head-related transfer functions (HRTF) matching the loudspeaker position. In spatial hearing, a directional sound source travels two distinctive propagation paths to arrive at the left and right ears respectively. This results in the arrival-time and intensity differences between the two ear entrance signals, which is then exploited by the human auditory system to achieve localized hearing. These two propagation paths can be well modeled by a pair of direction-dependent acoustic filters, referred to as the head-related transfer functions. For example, given a sound source S located at direction φ, the ear entrance signals S_{left} and S_{right} can be modeled as:

$$[ \begin{matrix}{S}_{left} \\ {S}_{right}\end{matrix} ] = [ \begin{matrix}{H}_{left , ϕ} \\ {H}_{right , ϕ}\end{matrix} ] \cdot {S}^{T} \qquad ( 6 )$$

where H_{left,φ} and H_{right,φ} represent the HRTFs of direction φ. In practice, the HRTFs of a given direction can be measured by probe microphones inserted in the ears of a subject's (e.g., a person, a dummy head or the like) to pick up responses from an impulse, or a known stimulus, placed in the direction.

These HRTF measurements can be used to synthesize virtual ear entrance signals from a monophonic source. By filtering this source with a pair of HRTFs corresponding to a certain direction and presenting the resulting left and right signals to a listener via headphones or earphones, a sound field with a virtual sound source spatialized in the desired direction can be simulated. Using the four-speaker array described above, we can thus convert the W, X, and Y channels to binaural signals as follows:

$$[ \begin{matrix}{S}_{left} \\ {S}_{right}\end{matrix} ] = [ \begin{matrix}{H}_{left , 1} & {H}_{left , 2} & {H}_{left , 3} & {H}_{left , 4} \\ {H}_{right , 1} & {H}_{right , 2} & {H}_{right , 3} & {H}_{right , 4}\end{matrix} ] \cdot [ \begin{matrix}{L}_{1} \\ {L}_{2} \\ {L}_{3} \\ {L}_{4}\end{matrix} ] \qquad ( 7 )$$

where H_{left,n} represents the transfer function from the nth loudspeaker to the left ear, and H_{right,n} represents the transfer function from the nth loudspeaker to the right ear. This can be extended to more loudspeakers:

$$[ \begin{matrix}{S}_{left} \\ {S}_{right}\end{matrix} ] = [ \begin{matrix}{H}_{left , 1} & {H}_{left , 2} & … & {H}_{left , N} \\ {H}_{right , 1} & {H}_{right , 2} & … & {H}_{right , n}\end{matrix} ] \cdot [ \begin{matrix}{L}_{1} \\ {L}_{2} \\ ⋮ \\ {L}_{n}\end{matrix} ] \qquad ( 8 )$$

where n represents the total number of loudspeakers.

It would be appreciated that more complex sound field processing introduced later in this disclosure builds upon the aforementioned decoding method when the sound field is rendered through loudspeaker arrays or headphones.

In one example embodiment, a video endpoint device can be a video camera with at least one lens. The video camera can be located in vicinity of a screen or elsewhere where it can capture all the participants. Normally, a camera embedded with a wide-angle lens is capable of capturing a visual scene containing enough information for the participants at the other side. In an example embodiment, the lens can be zoomed in for emphasizing especially a speaking participant or a portion of the visual scene. It is to be noted that this example embodiments does not intend to limit the form or placement of a video endpoint device. Also, there can be more than one video endpoint device at one side. Typically, the example embodiment has the audio endpoint device placed away from the video endpoint device at a certain distance.

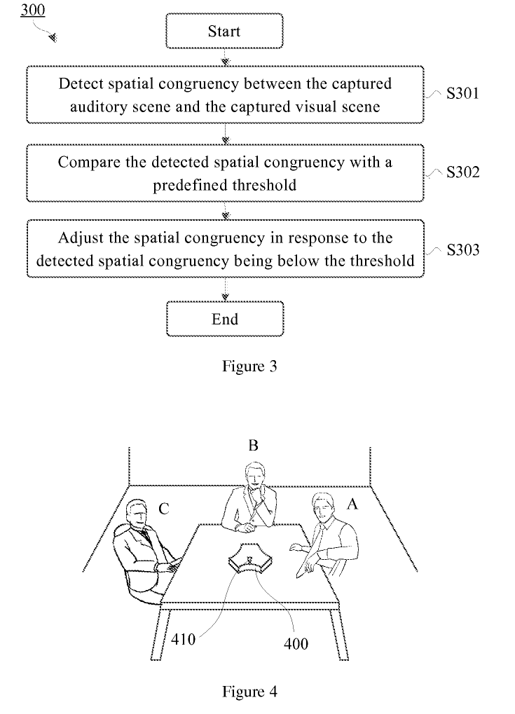

Reference is first made to FIG. 3 which shows a flowchart of a method 300 for adjusting the spatial congruency in a video conference in accordance with the example embodiments.

In a still environment that positions of all of the devices and audio objects are fixed, there exists no spatial congruency problem once settings are initially well adjusted, assuming talkers do not change their physical locations. However, in reality, the environment at either side in a video conference may vary constantly or occasionally. Such variations may include several scenarios. A first example scenario is that the audio endpoint device is moved, which results in a change of the captured sound field or auditory scene. Motion, especially rotation, of the audio endpoint device would cause significant discomfort, and thus should be compensated for as much as possible. A second example scenario is that the video endpoint device is changed, such as camera displacement or zoom-in/out. In this second example scenario, the sound field or captured auditory scene is stable but the captured visual scene is changed. Therefore, the captured auditory scene should be gradually altered (e.g., rotated) to match up with the captured visual scene in order to adjust the spatial congruency. A third possible example scenario is that the participants at either side in a video conference may move relative to the audio endpoint device, such as walking around the room, leaning in or moving closer to the audio endpoint device, etc., which may lead to noticeable changes in terms of angle, yet such changes are visually less noticeable. It is to be noted that more than one scenario may happen at one time.

In one example embodiment, an audio endpoint device such as the one shown in FIG. 1 is positioned in relation to a video endpoint device. In a typical conference setting at one side, there is provided a screen hung on a wall and a video camera is fixed above or beneath the screen for capturing a visual scene without blockage. Meanwhile, a few participants are seated surrounding an audio endpoint device in front of the screen and the video camera. Such a typical setting can be observed in FIG. 4, which shows a normal visual scene captured by a video camera at one side in a video conference.

In FIG. 4, there are three participants A, B and C seated around a table, on which an audio endpoint device 400 is placed. There may be a visual mark 401 on the audio endpoint device 400. The mark 410 can be used for initial alignment of the audio endpoint device 400. In one embodiment, the mark 410 is overlapped with the front direction as illustrated in FIG. 1. In other words, the audio endpoint device 400 may be positioned with its mark 410 pointing to the video endpoint device for ease of identifying any rotation or movement of the audio endpoint device 400. In one embodiment, the audio endpoint device 400 can be placed in front of the video camera of the video endpoint device, for example, on a vertical plane through the center of a lens or the video camera of the video endpoint device, and the vertical plane is perpendicular to the wall on which the camera is placed. Such a placement is beneficial for spatial congruency adjustment by placing the audio endpoint device in the medial plane of the captured image or visual scene.

It is to be noted, however, that the audio endpoint device can be positioned in relation to the video endpoint device before or after establishing the video conference session, and the example embodiment does not intend to restrict a time for such positioning.

At step S301, the spatial congruency between the captured auditory scene and the captured visual scene is detected, and in one possible example embodiment this detection is in real time. The spatial congruency can be represented by different indicators. For example, the spatial congruency may be represented by an angle. In one possible example embodiment, the spatial congruency may be represented by distance or percentage, considering the positions of the audio objects or participants can be compared with the captured visual scene in a space defined by the lens. This particular step S301 can be conducted in real time throughout the video conference session, including the initial detection of the spatial congruency just after initiating the video conference session.

At step S302, the detected spatial congruency is compared with a predefined threshold. In a particular example that the spatial congruency is represented by an angle as described above, the predefined threshold value can be 10°, meaning that the captured auditory scene is offset by 10° compared with the captured visual scene. As a result, a discrepancy in angle greater than 10° would trigger the adjustment of step S303, which will be described in the following.

At step S303, the spatial congruency is adjusted in response to, for example, the discrepancy between the captured auditory scene and the captured visual scene exceeding a predefined threshold value or the spatial congruency below the threshold as described above.

The detection of the spatial congruency between the captured auditory scene and the captured visual scene at step S301 can be further performed by at least one of a guided approach and a blind approach, which will be described in detail in the following.

### Guided Approach

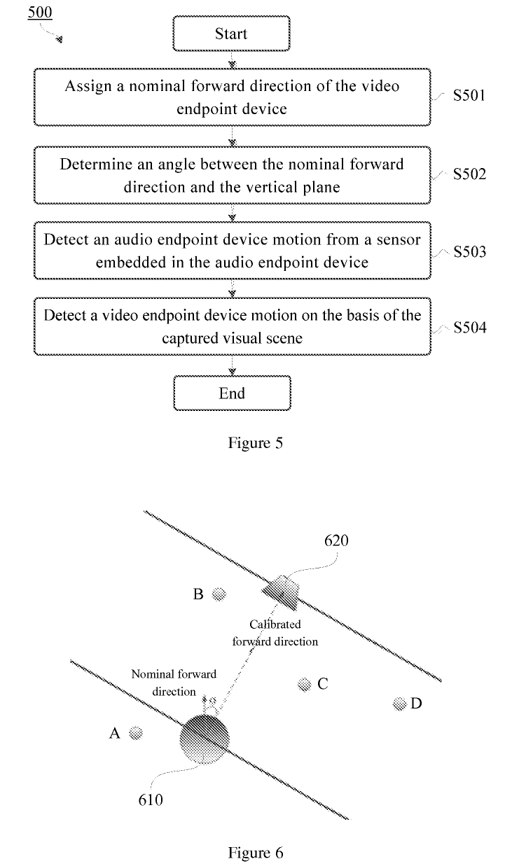

Reference is made to FIG. 5 which shows a flowchart of a method 500 for detecting the spatial congruency in accordance with the example embodiments of the present invention.

At step S501, a nominal forward direction of the video endpoint device can be assigned. The nominal forward direction may be overlapped, or not be overlapped, with the front direction as shown in FIG. 1. In one example embodiment, the nominal forward direction can be denoted by the mark 410 on the audio endpoint device 400 in FIG. 4 which is overlapped with the front direction, in order to simplify the calculation. In another example embodiment, the nominal forward direction denoted by the mark 410 may not be overlapped with the front direction but with certain angle in between. For example, in FIG. 6, if the nominal forward direction is overlapped with the front direction of the microphone array, a 180 degree rotation may be applied to the sound field on top of the angle difference between the nominal forward direction and calibrated forward direction. On the other hand, if the normal forward direction has a 180 degree angle difference with the front direction of the microphone array, the aforementioned additional rotation is not needed.

At step S502, an angle between the nominal forward direction and the vertical plane through the center of the lens of the video endpoint device can be determined. This particular angle can be determined by different ways. For example, when the nominal forward direction is overlapped with the mark 410 as described above, the mark 410 can be identified by the video endpoint device and an angle difference may be calculated and generated by a preset program. By identifying the angle difference between the nominal forward direction and the vertical plane, the auditory scene or sound field can be rotated accordingly to compensate this difference, for example, by using equation (2) as described above. In other words, an initial calibration may be done along with positioning the audio endpoint device in relation to the video endpoint device. Advantageously, the time required for detecting the spatial congruency will be less if users put the audio endpoint device 400 on the vertical plane as described above and rotate the audio endpoint device 400 so that the mark 410 is rightly facing the lens of the video endpoint device, with reference to FIG. 4.

At step S503, an audio endpoint device motion from a sensor embedded in the audio endpoint device can be detected. By incorporating a sensor such as a gyroscope and an accelerometer, the rotation or orientation of the audio endpoint device is detectable, which enables the detection of the spatial congruency in real time in response to any change of the audio endpoint device itself. In one example embodiment, the motion of the audio endpoint device, such as rotation, can be obtained by analyzing the change of the mark on the audio endpoint device relative to the video endpoint device. It is to be noted, however, that a mark is not necessary to be presented on the audio endpoint device if the shape of the audio endpoint device is identifiable by the video endpoint device.

At step S504, a video endpoint device motion can be detected on the basis of the captured visual scene. Specifically, camera motions, such as pan, tilt, zoom and the like, can be obtained directly from the camera or based on the analysis of the captured images. When a motion is directly obtained from the camera, information from the hardware of the camera can be used for detecting the motion of the video endpoint device.

Either the audio endpoint device motion or the video endpoint device motion can trigger the adjustment of the spatial congruency once that the discrepancy surpasses the predefined threshold value.

In one example embodiment, as shown in FIG. 6, an audio endpoint device 610 can be a typical sound capturing device including three microphones with its nominal forward direction pointing to a first direction, as shown by the solid arrow. As shown in FIG. 6, there are 4 participants in the space, namely A, B, C, and D, whose position information can be obtained by auditory scene analysis. A video endpoint device 620 is placed away from the audio endpoint device 610 at a certain distance, and its lens is directly facing the audio endpoint device 610. In other words, the audio endpoint device 610 is positioned on the vertical plane through the center of the lens of the video endpoint device 620. Because the nominal forward direction is not directed to the video endpoint device 620, a calibrated forward direction may need to be compensated with regard to the nominal forward direction initially, once the placement of both the audio endpoint device 610 and the video endpoint device 620 are fixed. The angle difference σ as shown in FIG. 6 between the first direction and the calibrated forward direction is easily compensated, for example, by equation (2).

As described above, the angle difference σ can be obtained by identifying a mark on the audio endpoint device 610. If a mark is absent, in one example embodiment, a communication module (not shown) in the audio endpoint device 610 capable of transmitting the orientation information of the audio endpoint device 610 to the video endpoint device 620 can be provided in order to obtain the angle difference σ.

By using a sensor embedded in the audio endpoint device 610, such as a gyroscope sensor, for detecting the motion of the audio endpoint device 610, any rotation of the audio endpoint device can be detected instantly, so that the real-time detection of the spatial congruency becomes possible.

In one example embodiment, especially when the audio endpoint device 610 is not placed right in front of the lens of the video endpoint device 620, the lens or camera can be turned left or right by a certain angle, in order to put the audio endpoint device 610 on the vertical plane or zoom it in on a speaking participant. This may result in a person in the visual scene respectively at the left or right of the captured image moving toward the middle of the image. This variation of the captured visual scene needs to be known in order to manipulate the captured auditory scene for adjusting the spatial congruency.

In addition to the rotated angle of the lens of the video endpoint device as described above, other information such as zoom level or vertical angle of the lens may also be useful for displaying all the participants or showing a particular someone, for example, who has been speaking for a while.

The guided approach may rely on devices embedded in both of the audio endpoint device and the video endpoint device. With such devices communicating among each other, any change during the video conference can be instantly detected. For instance, such changes may include rotation, relocation, and tilting of each of the endpoint devices.

### Blind Approach

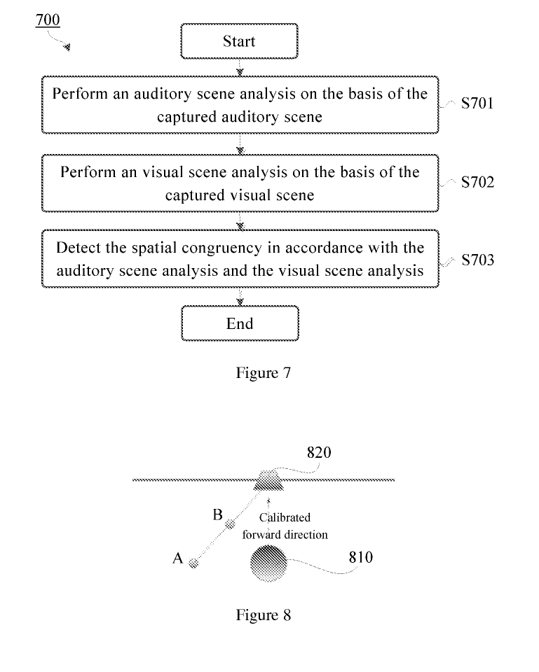

Reference is made to FIG. 7 which shows a flowchart of a method 700 for detecting the spatial congruency in accordance with example embodiments.

In addition to the guided approach described above which has to utilize some a priori knowledge, for example, orientation information from sensors embedded in either the audio endpoint device or the video endpoint device, a blind approach based on analyzing the captured visual and/or audio scenes can be useful when such information is not available.

At step S701, an auditory scene analysis (ASA) can be performed on the basis of the captured auditory scene in order to identify an auditory distribution of the audio objects, where the auditory distribution is a distribution of the audio objects relative to the audio endpoint device. For example, by reference to FIG. 4, participants A, B, and C are around the audio endpoint device 400, and thus constitute an auditory distribution in the space.

In one example embodiment, ASA can be realized by several techniques. For example, a directional-of-arrival (DOA) analysis may be performed for each of the audio objects. Some popular and known DOA methods in the art include Generalized Cross Correlation with Phase Transform (GCC-PHAT), Steered Response Power-Phase Transform (SRP-PHAT), Multiple Signal Classification (MUSIC) and the like. Most of the DOA methods known in the art are already apt to analyze the distribution of the audio objects, i.e., participants in a video conference. ASA can also be performed by estimating depth/distance, signal level, and diffusivity of an audio object. The diffusivity of an audio object represents the degree of how reverberant the acoustic signal arriving at the microphone location from a particular source. Additionally or alternatively, speaker recognition or speaker diarization methods can be used to further improve ASA. A speaker recognition system employs spectral analysis and pattern matching to identify the participant identity against existing speaker models. A speaker diarization system can segment and cluster the history meeting recordings, such that each speech segment is assigned to a participant identity. Additionally or alternatively, conversation analysis can be performed to examine the interactivity patterns among participants, i.e., a conversational interaction between the audio objects. In its simplest form, one or more dominant or key audio objects can be identified by checking the verbosity for each participant. Knowing which participant speaks the most not only helps in aligning audio objects better, but also allows making the best trade-off when a complete spatial congruency cannot be achieved. That is, at least the key audio object may be ensured with a satisfying congruency.

It is to be noted that, most of the known ASA techniques are capable of identifying the auditory distribution of the audio objects, and thus these techniques will not be elaborated in detail herein.

At step S702, a visual scene analysis (VSA) can be performed on the basis of the captured visual scene in order to identify a visual distribution of the audio objects, where the visual distribution is a distribution of the audio objects relative to the video endpoint device. For example, with reference to FIG. 4, participants A, B, and C are distributed in a captured visual scene and thus constitute a visual distribution relative to the video endpoint device.

In one example embodiment, VSA can also be realized by several techniques. Most of the techniques may involve object detection and classification. In this context, video and audio objects as participants who can speak, are of main concern and are to be detected. For example, by analyzing the captured visual scene, existing face detection/recognition algorithms in the art can be useful to identify the object's position in a space. Additionally, a region of interest (ROI) analysis or other object recognition methods may optionally be used to identify the boundaries of target video objects, for example, shoulders and arms when faces are not readily detectable. Once faces of the participants are found in the captured visual scene, an ROI for the faces can be created and then a lip detection may be performed on the faces as the lip motion is a useful cue for associating a participant with an audio object and examining if the participant is speaking or not.

It is to be noted that, most of the known VSA techniques are capable of identifying the visual distribution of the audio objects, and thus these techniques will not be elaborated in detail herein.

In yet another example embodiment, identities of the participants may be recognized, which is useful for matching audio with video signals in order to achieve congruency. At step S703, the spatial congruency may be detected in accordance with the resulting ASA and/or VSA.

Once the spatial congruency is obtained, the adjustment of the spatial congruency at step S303 can be performed. The adjustment of the spatial congruency can include either or both of the auditory scene adjustment and the visual scene adjustment. As described above, if the detected spatial congruency is below a certain threshold (step S302), the adjustment may be triggered. Previous examples use angles in degrees to represent the match or mismatch of the visual scene and the auditory scene. However, more sophisticated representations may also be used to represent a match or a mismatch. For example, a simulated 3D space may be generated to have one or more participants mapped in the space, each having a value corresponding to his/her physical position. Another simulated 3D space can be generated to have the same participants mapped in the space, each having a value corresponding to his/her perceived position in the sound field. The two generated spaces may be compared to generate the spatial congruency or interpreted in order to facilitate the adjustment of the spatial congruency.

There are several methods that can be used to adjust the spatial congruency. In one embodiment, as described above, equation (2) can be used to rotate the captured auditory scene by any preferred angle. Rotation can be a simple yet effective way to adjust the spatial congruency, for example, in response to the audio endpoint device being rotated.

In another example embodiment, the captured auditory scene may be mirrored with regard to an axis defined by the video endpoint device. For example, by referring to FIG. 6, the captured visual scene does not match the auditory scene. For instance, the participant B is located approximately in the nominal forward direction of the audio endpoint device 610, or appears to the left of the calibrated forward direction, assuming the nominal forward direction is the front direction of the microphone array. On the other hand, the same participant B will be on the right hand side in the captured visual scene. As mentioned previously, we could rotate the sound field using equation (2) by 180 degrees such that objects A-D will be on the correct sides matching the visual scene. Alternatively, a sound field mirroring operation can be performed such that audio objects are reflected with regard to the vertical plane between the audio endpoint and the video endpoint (θ is the angle between an audio object and the axis used for reflection). The mirroring of the auditory scene can be performed by the following equation (3), which would be appreciated by a person skilled in the art as a reflection operation in Euclidean geometry:

$$[ \begin{matrix}{W}^{′} \\ {X}^{′} \\ {Y}^{′}\end{matrix} ] - [ \begin{matrix}1 & 0 & 0 \\ 0 & cos ( 2 θ ) & sin ( 2 θ ) \\ 0 & sin ( 2 θ ) & - cos ( 2 θ )\end{matrix} ] [ \begin{matrix}W \\ X \\ Y\end{matrix} ] \qquad ( 9 )$$

Therefore, in the example as shown in FIG. 6, the four participants are mirrored relative to the calibrated forward direction after the mirroring step. It should be noted that any approach above may need additional sound field operations in order to achieve greater spatial congruency. For example, after rotating the sound field or captured auditory scene, audio objects B, C, and D may appear as coming from behind from the listener's perspective whereas visually they are all in front of the viewers. Similarly, although a simple reflection or mirror process may flip the objects to the correct side, their distance perception in the audio scene does not match that in the visual scene. These issues become more apparent in the example shown below.

In another example scenario as shown in FIG. 8, sound field rotation or reflection described above may not realize full spatial congruency. In FIG. 8, the participants A and B will appear to be slightly apart from each other as seen from the video endpoint device 820. However, the two participants will sound greatly apart from each other as directly captured by the audio endpoint device 810. In view of the above, the captured auditory scene may need to be scaled, moved, or squeezed to match the captured visual scene. Moving the sound field or the auditory scene consists of a translation operation using the term in Euclidean geometry. Together with scaling or squeezing the sound field, an alternation of the B-format decoding process previously described is needed.

Several example techniques are described below: UHJ downmixing, which converts WXY B-format to two-channel stereo signals (the so-called C-format); or squeezing, whereas a full 360 surround sound field is “squeezed” into a smaller sound field. For example, the 360° sound field can be squeezed into a 60° stereo sound field as if the sound field is rendered through a pair of stereo loudspeakers in front of a user. Alternatively, a full-frontal headphone virtualization may be utilized, by which a 360° sound field surrounding a user is re-mapped to a closed shape in the vertical plane, for example a circle or an ellipse, in front of the user.

Another possible scenario to scale the captured auditory scene is that when the lens of the video endpoint device is zoomed in or zoomed out. The captured auditory scene may need to be scaled wider and scaled narrower, respectively, in order to maintain a proper spatial congruency.

Achieving spatial congruency is not limited to sound field processing. It would be appreciated that sometimes the visual scene may be adjusted in addition to the auditory scene adjustment for improving the spatial congruency. For example, the camera of the video endpoint device may be rotated, displaced or zoomed in/out for aligning the captured visual scene with the captured auditory scene. Alternatively, the captured visual scene may be processed without changing the physical status of the video endpoint device. For example, the captured visual scene may be cropped, scaled, or shifted to match the captured auditory scene.

In one example embodiment, the detection of the spatial congruency as described in step S301 may be performed in-situ, meaning that the captured auditory scene and visual scene are co-located and the corresponding signals are generated at the caller side before being sent to the callee side. Alternatively, the spatial congruency may be detected at a server in the transmission between the caller side and the callee side, with only captured auditory data and visual data sent from the caller side. Performing detection at the server would reduce the computing requirements at the caller side.

In one embodiment, the adjustment of the spatial congruency as described in step S303 may be performed at a server in the transmission between the caller side and the callee side. Alternatively, the spatial congruency may be adjusted at the callee side after the transmission is done. Performing adjustment at the server would reduce the computing requirements at the callee side.

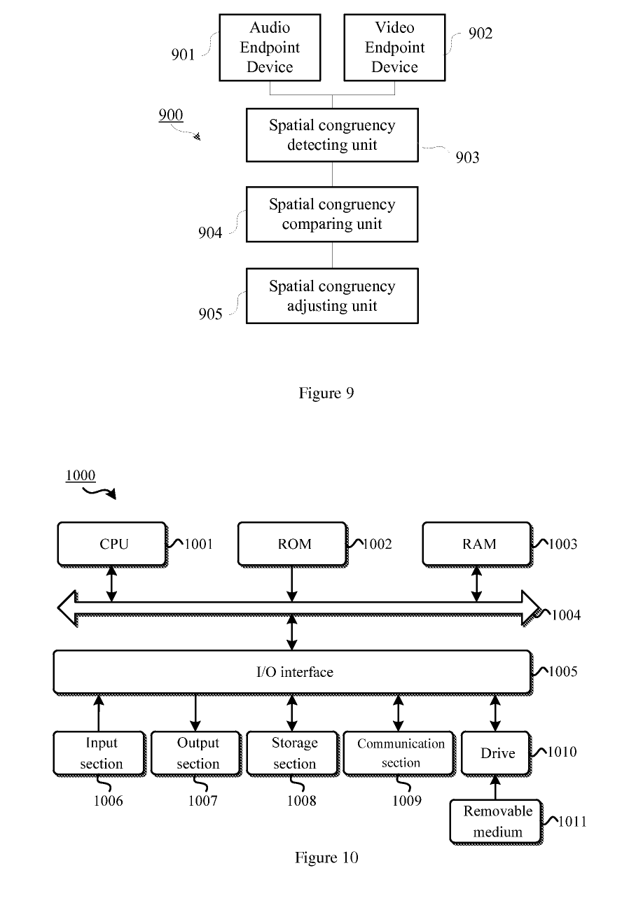

FIG. 9 shows a block diagram of a system 900 for adjusting spatial congruency in a video conference in accordance with one example embodiment as shown. As shown, the system 900 includes an audio endpoint device 901 configured to capture the auditory scene, a video endpoint device 902 configured to capture the visual scene, a spatial congruency detecting unit 903 configured to detect the spatial congruency between the captured auditory scene and the captured visual scene, a spatial congruency comparing unit 904 configured to compare the detected spatial congruency with a predefined threshold, and an spatial congruency adjusting unit 905 configured to adjust the spatial congruency in response to the detected spatial congruency less than a predefined threshold.

In some embodiments, the audio endpoint device 901 may be positioned on a vertical plane through the center of the lens of the video endpoint device 902.

In these embodiments, the spatial congruency detecting unit 903 may include an angle determining unit configured to determine an angle between a nominal forward direction and the vertical plane, an audio endpoint device detecting unit configured to detect an audio endpoint device motion from a sensor embedded in the audio endpoint device 901, and a video endpoint device detecting unit configured to detect a video endpoint device motion on the basis of an analysis of the captured visual scene.

In some example embodiments, the spatial congruency detecting unit 903 may comprise an auditory scene analyzing unit configured to perform an auditory scene analysis on the basis of the captured auditory scene in order to identify an auditory distribution of an audio object, the auditory distribution being a distribution of the audio object relative to the audio endpoint device 901, a visual scene analyzing unit configured to perform a visual scene analysis on the basis of the captured visual scene in order to identify a visual distribution of the audio object, the visual distribution being a distribution of the audio object relative to the video endpoint device 902 and the spatial congruency detecting unit 903 is configured to detect the spatial congruency in accordance with the auditory scene analysis and the visual scene analysis. In these example embodiments, the auditory scene analyzing unit may further include at least a DOA analyzing unit configured to analyze a direction of arrival of the audio object, a depth analyzing unit configured to analyze a depth of the audio object, a key object analyzing unit configured to analyze a key audio object, and a conversation analyzing unit configured to analyze a conversational interaction between audio objects. In these example embodiments, the visual scene analyzing unit may further include at least one a face analyzing unit configured to perform a face detection or recognition for the audio object, a region analyzing unit configured to analyze a region of interest for the captured visual scene and a lip analyzing unit configured to perform a lip detection for the audio object.

In some example embodiments, the spatial congruency adjusting unit 905 may comprise at least an auditory scene rotating unit configured to rotate the captured auditory scene; an auditory scene mirroring unit configured to mirror the captured auditory scene with regard to an axis defined by the video endpoint device, an auditory scene translation unit configured to translate the captured auditory scene, an auditory scene scaling unit configured to scale the captured auditory scene and a visual scene adjusting unit configured to adjust the captured visual scene.

In some example embodiments, the spatial congruency may be detected in-situ or at a server. In some example embodiments, the captured auditory scene may be adjusted at a server or at a receiving end of the video conference.

For the sake of clarity, some optional components of the system 900 are not shown in FIG. 9. However, it should be appreciated that the features as described above with reference to FIGS. 1 to 8 are all applicable to the system 900. Moreover, the components of the system 900 may be a hardware module or a software unit module. For example, in some embodiments, the system 900 may be implemented partially or completely with software and/or firmware, for example, implemented as a computer program product embodied in a computer readable medium. Alternatively or additionally, the system 900 may be implemented partially or completely based on hardware, for example, as an integrated circuit (IC), an application-specific integrated circuit (ASIC), a system on chip (SOC), a field programmable gate array (FPGA), and so forth. The scope of the present invention is not limited in this regard.

FIG. 10 shows a block diagram of an example computer system 1000 suitable for implementing embodiments of the present invention. As shown, the computer system 1000 includes a central processing unit (CPU) 1001 which is capable of performing various processes in accordance with a program stored in a read only memory (ROM) 1002 or a program loaded from a storage section 1008 to a random access memory (RAM) 1003. In the RAM 1003, data required when the CPU 1001 performs the various processes or the like is also stored as required. The CPU 1001, the ROM 1002 and the RAM 1003 are connected to one another via a bus 1004. An input/output (I/O) interface 1005 is also connected to the bus 1004.

The following components are connected to the I/O interface 1005: an input section 1006 including a keyboard, a mouse, or the like; an output section 1007 including a display, such as a cathode ray tube (CRT), a liquid crystal display (LCD), or the like, and a speaker or the like; the storage section 1008 including a hard disk or the like; and a communication section 1009 including a network interface card such as a LAN card, a modem, or the like. The communication section 1009 performs a communication process via a network such as the internet. A drive 1010 is also connected to the I/O interface 1005 as required. A removable medium 1011, such as a magnetic disk, an optical disk, a magneto-optical disk, a semiconductor memory, or the like, is mounted on the drive 1010 as required, so that a computer program read therefrom is installed into the storage section 1008 as required.

Specifically, in accordance with the embodiments of the present invention, the processes described above with reference to FIGS. 1 to 9 may be implemented as computer software programs. For example, the embodiments of the present invention comprise a computer program product including a computer program tangibly embodied on a machine readable medium, the computer program including program code for performing methods 300, 500, 700 and/or 900. In such embodiments, the computer program may be downloaded and mounted from the network via the communication section 1009, and/or installed from the removable medium 1011.

Generally speaking, various example embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to perform the associated function(s). For example, the embodiments of the present invention include a computer program product comprising a computer program tangibly embodied on a machine readable medium, the computer program containing program codes configured to perform the methods as described above.

In the context of the disclosure, a machine readable medium may be any tangible medium that can contain, or store a program for use by or in connection with an instruction execution system, apparatus, or device. The machine readable medium may be a machine readable signal medium or a machine readable storage medium. A machine readable medium may include, but is not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for performing methods of the present invention may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may be executed entirely on a computer, partly on the computer, as a stand-alone software package, partly on the computer and partly on a remote computer or entirely on the remote computer or server.

Further, while operations are depicted in a particular order, this should not be understood as requiring that such operations be performed in the particular order shown or in a sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Various modifications, adaptations to the foregoing example embodiments may become apparent to those skilled in the relevant arts in view of the foregoing description, when read in conjunction with the accompanying drawings. Any and all modifications will still fall within the scope of the non-limiting and example embodiments. Furthermore, other example embodiments set forth herein will come to mind of one skilled in the art to which these embodiments pertain to having the benefit of the teachings presented in the foregoing descriptions and the drawings.

1-19. (canceled)

20. A method for adjusting spatial congruency in a video conference, the method comprising:
detecting spatial congruency between a visual scene captured by a video endpoint device and an auditory scene captured by an audio endpoint device that is positioned in relation to the video endpoint device, the spatial congruency being a degree of alignment between the auditory scene and the visual scene;
comparing the detected spatial congruency with a predefined threshold; and
in response to the detected spatial congruency being below the threshold, adjusting the spatial congruency.

21. The method according to claim 20 wherein the audio endpoint device is positioned on a vertical plane through a center of a lens of the video endpoint device.

22. The method according to claim 21 wherein detecting the spatial congruency comprises:
assigning a nominal forward direction of the video endpoint device;
determining an angle between the nominal forward direction and the vertical plane;
detecting an audio endpoint device motion from a sensor embedded in the audio endpoint device; and
detecting a video endpoint device motion on the basis of the captured visual scene.

23. The method according to claim 20 wherein detecting the spatial congruency between the captured auditory scene and the captured visual scene comprises:
performing an auditory scene analysis on the basis of the captured auditory scene in order to identify an auditory distribution of an audio object, the auditory distribution being a distribution of the audio object relative to the audio endpoint device;
performing a visual scene analysis on the basis of the captured visual scene in order to identify a visual distribution of the audio object, the visual distribution being a distribution of the audio object relative to the video endpoint device; and
detecting the spatial congruency in accordance with the auditory scene analysis and the visual scene analysis.

24. The method according to claim 23 wherein performing the audio scene analysis comprises at least one of:
analyzing a directional of arrival of the audio object;
analyzing a depth of the audio object;
analyzing a key audio object; and
analyzing a conversational interaction between the audio objects.

25. The method according to claim 23 wherein performing the visual scene analysis comprises at least one of:
performing a face detection or recognition for the audio object;
analyzing a region of interest for the captured visual scene; and
performing a lip detection for the audio object.

26. The method according to claim 20 wherein adjusting the spatial congruency comprises at least one of:
rotating the captured auditory scene;
translating the captured auditory scene with regard to the audio endpoint device;
mirroring the captured auditory scene with regard to the audio endpoint device;
scaling the captured auditory scene; and
adjusting the captured visual scene.

27. The method according to claim 20 wherein the spatial congruency is detected in-situ or at a server.

28. The method according to claim 20 wherein the spatial congruency is adjusted at a server or at a receiving end of the video conference.

29. A system for adjusting spatial congruency in a video conference, the system comprising:
a video endpoint device configured to capture a visual scene;
an audio endpoint device configured to capture an auditory scene that is positioned in relation to the video endpoint device;
a spatial congruency detecting unit configured to detect the spatial congruency between the captured auditory scene and the captured visual scene, the spatial congruency being a degree of alignment between the auditory scene and the visual scene;
a spatial congruency comparing unit configured to compare the detected spatial congruency with a predefined threshold; and
a spatial congruency adjusting unit configured to adjust the spatial congruency in response to the detected spatial congruency being below the threshold.

30. The system according to claim 29 wherein the audio endpoint device is positioned on a vertical plane through a center of a lens of the video endpoint device.

31. The system according to claim 30 wherein the spatial congruency detecting unit comprises:
an angle determining unit configure to determine an angle between a nominal forward direction and the vertical plane;
an audio endpoint device detecting unit configured to detect an audio endpoint device motion from a sensor embedded in the audio endpoint device; and
a video endpoint device detecting unit configured to detect a video endpoint device motion on the basis of an analysis of the captured visual scene.

32. The system according to claim 29 wherein the spatial congruency detecting unit comprises:
an auditory scene analyzing unit configured to perform an auditory scene analysis on the basis of the captured auditory scene in order to identify an auditory distribution of an audio object, the auditory distribution being a distribution of the audio object relative to the audio endpoint device; and
a visual scene analyzing unit configured to perform a visual scene analysis on the basis of the captured visual scene in order to identify a visual distribution of the audio object, the visual distribution being a distribution of the audio object relative to the video endpoint device,
wherein the spatial congruency detecting unit is configured to detect the spatial congruency in accordance with the auditory scene analysis and the visual scene analysis.

33. The system according to claim 32 wherein the auditory scene analyzing unit comprises at least one of:
a directional of arrival analyzing unit configured to analyze a directional of arrival of the audio object;
a depth analyzing unit configured to analyze a depth of the audio object;
a key object analyzing unit configured to analyze a key audio object; and
a conversation analyzing unit configured to analyze a conversational interaction between the audio objects.

34. The system according to claim 32 wherein the visual scene analyzing unit comprises at least one of:
a face analyzing unit configured to perform a face detection or recognition for the audio object;
a region analyzing unit configured to analyze a region of interest for the captured visual scene; and
a lip analyzing unit configured to perform a lip detection for the audio object.

35. The system according to claim 29 wherein the spatial congruency adjusting unit comprises at least one of:
an auditory scene rotating unit configured to rotate the captured auditory scene;
an auditory scene translating unit configured to translate the captured auditory scene with regard to the audio endpoint device;
an auditory scene mirroring unit configured to mirror the captured auditory scene with regard to the audio endpoint device;
an auditory scene scaling unit configured to scale the captured auditory scene; and
a visual scene adjusting unit configured to adjust the captured visual scene.

36. The system according to claim 29 wherein the spatial congruency is detected in-situ or at a server.

37. The system according to claim 29 wherein the spatial congruency is adjusted at a server or at a receiving end of the video conference.

38. A computer program product for adjusting spatial congruency in a video conference, the computer program product being tangibly stored on a non-transient computer-readable medium and comprising machine executable instructions which, when executed, cause a machine to perform steps of the method according to claim 20.
